(19) United States
(12) Patent Application Publication
(10) Pub. No.: US 2010/0250234 A1
(43) Pub. Date: Sep. 30, 2010

(54) Receipt Translation for Vouchering

(75) Inventors: Kouros Azimi, Center Valley, PA (US); Sailesh Merchant, Macungie, PA (US)

Correspondence Address: IP Legal Services, 1500 East Lancaster Avenue, Suite 200, P.O. Box 1027, Paoli, PA, 19301, US

(73) Assignee: LSI Corporation

(21) Appl. No.: 12/413,958

(22) Filed: Mar. 30, 2009

(51) Int. Cl. G06F 17/28

(52) U.S. Cl. 704/7

(57) ABSTRACT

In described embodiments, a point of sale system, such as a cash register, provides for translation from standard language to desired native language on a receipt. Translation might be initiated through user (e.g., purchaser) input, manually or from a credit card, for example, and translation is accomplished through a database accessed by the point of sale system. Consequently, the point of sale system provides at least one receipt to the purchaser that identifies purchases as line item descriptions, and, in some cases, the price paid for each line item, in the purchaser's native language that might be used, for example, to accurately prepare vouchers.

### BACKGROUND OF THE INVENTION

1. Field of the Invention

The present invention relates to translation of receipts into a user's native language for use in vouchering.

2. Description of the Related Art

Increasingly, business is conducted internationally through face-to-face meetings in lands foreign to a company employee. Concurrently, companies are increasingly careful about accounting to adequately track and allocate costs and expenses to the company. When an employee returns from a business trip, the employee submits a voucher of expenditures incurred during the trip. Often, for international meetings, the employee has received receipts that are in a foreign language. For example, when the employee speaks English and works for an American company, the employee will generally submit the voucher in English. However, if the meeting is in Japan, the receipts are in Japanese with Japanese characters, but the employee might not be able to read Japanese characters. FIG. 1 illustrates two foreign receipts, one in Japanese for coffee (receipt 101) and one in Japanese for a bank currency exchange (receipt 102). As shown by receipts 101 and 102, a person who only speaks and writes English cannot discern what line items are in receipts 101 and 102.

Thus, at least two problems arise with respect to accurate vouchering by the employee. First, it is difficult for the employee to determine what each line item in a foreign receipt corresponds to, but the company might require that expenses for food and liquor be separated, and these expenses be separated from expenses for entertainment and for purchase of supplies and equipment. Second, from a company's standpoint, is a problem that an employee might try to hide personal expenses on a corporate voucher. For example, the employee might purchase, against company policy, an adult massage at “Happy Garden” in Taiwan, yet voucher the purchase as a lunch meal with a sales opportunity.

### SUMMARY OF THE INVENTION

In described embodiments, the present invention provides for receipt translation by receiving one or more product identifiers and associating each received product identifier with a corresponding entry in a database of product identification information. Each entry of the database corresponds to a product identifier, and each entry comprises a description field having a standard language description and one or more native language descriptions. Receipt language information is received and the native language description is selected for each received product identifier based on the received receipt language information.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows two receipts in Japanese for international purchases;

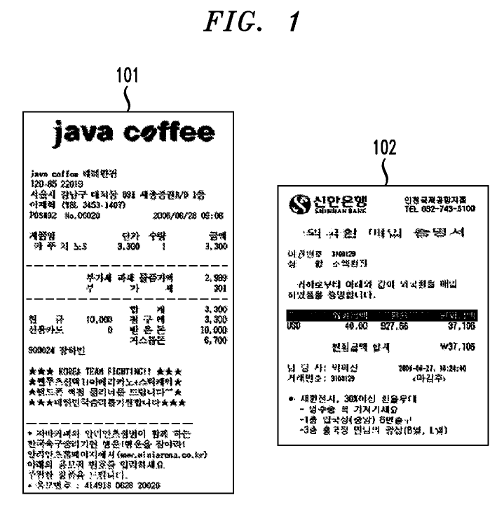

FIG. 2 shows a block diagram of a point of sale system operating in accordance with an exemplary embodiment of the present invention; and

FIG. 3 shows a block diagram of an exemplary method of receipt translation in accordance with the exemplary embodiment of the present invention.

### DETAILED DESCRIPTION

In accordance with embodiments of the present invention, a point of sale system, such as a cash register, provides for translation from standard language to desired native language on a receipt. Translation might be initiated through user (e.g., purchaser) input, manually or from a credit card, for example, and translation is accomplished through a database accessed by the point of sale system. Consequently, the point of sale system provides at least one receipt to the purchaser that identifies purchases as line item descriptions, and, in some cases, the price paid for each line item, in the purchaser's native language that might be used, for example, to accurately prepare vouchers.

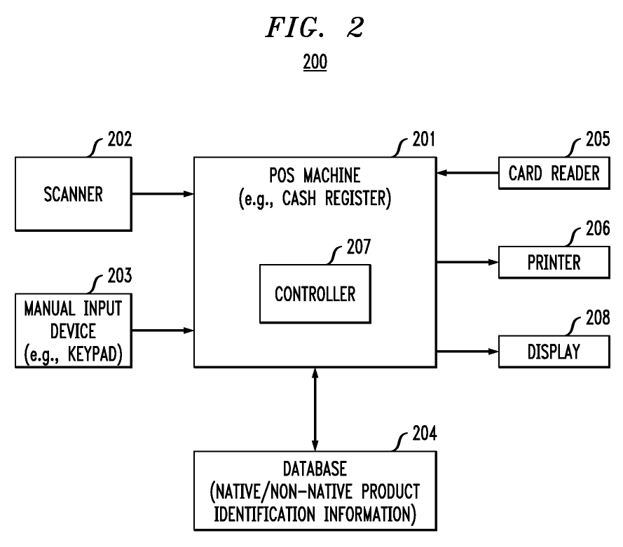

FIG. 2 shows a block diagram of point of sale system 200 operating in accordance with an exemplary embodiment of the present invention. As shown in FIG. 2, point of sale system 200 comprises point of sale (POS) machine 201 implementing traditional functionality of, for example, a cash register. Machine 201 receives, as input through a sensor, product identification information read from a product either from scanner 202 (which might be a bar-code scanner) or from manual input device 203 (which might be a traditional user input keypad system). Product identification information might be stored in database 204. Machine 201 might coupled to card reader 205 for obtaining, for example, credit card information read from a credit card swiped through card reader 205. Machine 201 is coupled to printer 206, which, in response to signals from machine 201, prints receipts for purchase and credit card transactions.

Machine 201 includes controller 207, which might be a computer processor or similar device along attendant circuitry, to perform general accounting functions for i) associating product identification information from database 204 with pricing and totaling the amount purchased, coordinating and collecting information from manual input device 203 and card reader 205, initiating credit card purchases through card reader 205, and managing communications for printing receipts with printer 206. As described previously, database 204 comprises product identification information that, for a given product, includes a description field, SKU (Stock-Keeping Unit) or other product identifier, and price information.

Machine 208 might also be coupled to display 208. Display 208 might be, for example, a CRT, LCD, or plasma display employed to show scanned or user-input product identification information read from a product, total and payment information, and user/purchaser prompts. Such prompts might be questions to ask a purchaser, such as whether a translated receipt might be desired. Functions and data associated with display 208 might also be coordinated and processed through controller 207.

In accordance with exemplary embodiments of the present invention, the description field includes i) a standard language description of the product associated with the product identifier, which standard language description employs a character set is in the pre-programmed standard language of the point of sale system, and ii) one or more native language descriptions of the product associated with the product identifier. For example, if the point of sale system 200 were employed in Japan, the character set for the standard language description of the product associated with the product identifier is in Japanese.

For each native language description, the character set corresponds to the same description but in a different language from the standard language. For example, the description field might include the standard language description of the product in Japanese with Japanese characters, but also include a first native language description of the product in English with an English character set, a second native language description of the product in Korean with a Korean character set, a third native language description of the product in Mandarin Chinese with a Chinese character set, a fourth native language description of the product in French with a French character set, a fifth native language description of the product in German with a German character set, and so on.

Machine 201 might receive input through a sensor as to desired non-native descriptions by direct user input from manual input device 203. For example, a teller might discuss with the purchaser if the purchaser desires the receipt in the native language or in a desired native language. Based on the purchaser's response, the teller would input what type of receipt should be printed. Alternatively, a user might have a credit card that includes, in the magnetic strip, information as to a desired default language. The magnetic strip of a credit card typically accommodates up to three tracks, Card reader 205 might include a sensor configured to read a language option from one of the three tracks of the card, such as default language from the “Discretionary Data” field of the magnetic strip. Such technique might be extended to other types of magnetic card readers in a straightforward manner, or might be extended by communication to machine 201 through some other device, such as through near-field communication from a mobile phone handset.

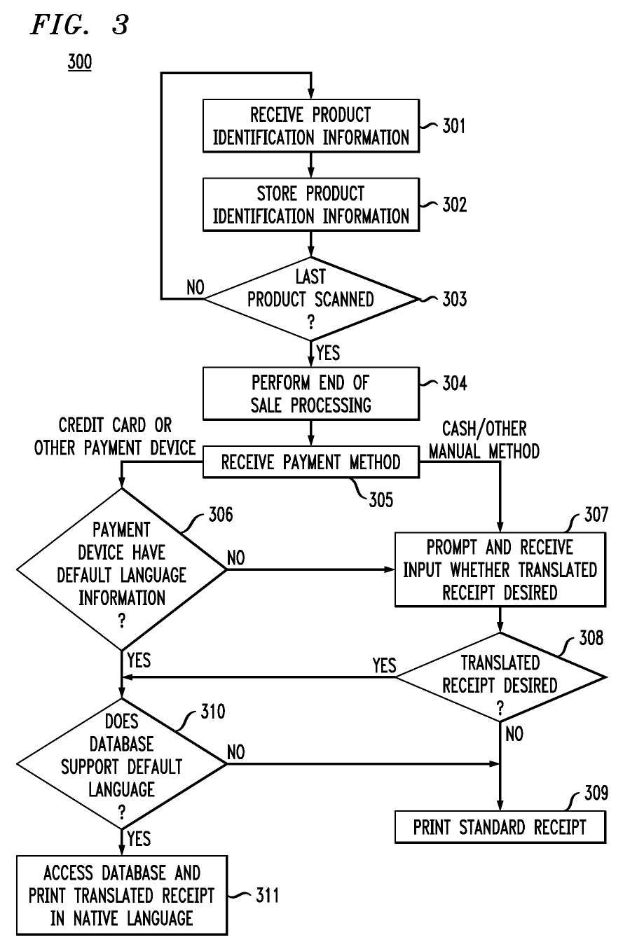

FIG. 3 shows a block diagram of an exemplary method 300 of receipt translation in accordance with the exemplary embodiment of the present invention. At step 301, a product item is scanned and product identification information received. At step 302, the scanned product identification information is stored. For the exemplary method shown and described, product identification information is received as scanned bar code information from a scanner, but the present invention is not so limited. Other methods, including manual input, might be employed by a point of sale system to receive the product identification information.

At step 303, a test determines whether the last item has been scanned (such test might occur, for example, through a user hitting a “done” or “total” command, or by the user swiping a credit card or activating some other payment device). If the test of step 303 determines that the last item has not been scanned, the method returns to step 301 for the next item. If the test of step 303 determines that the last item has been scanned, the method advances to step 304 to perform end processing.

At step 305, the method receives input as to the payment method. Such payment method might be manually input by the user of the point of sale device, such as when the buyer tenders cash, or be by detection of a credit card or other payment device. If, at step 305, the payment method input is, for example, by credit card, then a test at step 306 determines whether the payment device has default language information. If the test of step 306 determines that the payment device has default language information, the method advances to step 310, described subsequently. If the test of step 306 determines that the payment device does not have default language information, or if, at step 305, the payment method input is manual, the method advances to step 307 to receive input as to whether a translated receipt is desired by the purchaser.

At step 307, the purchaser is prompted whether a receipt in the purchaser's native language is desired and the purchaser's response is received, which response includes an identification of the purchaser's native language. At step 308, a test determines if the purchaser's response is negative, indicating that no translated receipt is desired. If the test of step 308 determines that the purchaser's response is negative, the method advances to step 309 to print a standard receipt. If the test of step 308 determines that the purchaser's response is positive, indicating that a translated receipt is desired, the method advances to step 310.

At step 310, a test determines whether, based on either the default language information or the user input information as to of the purchaser's native language, whether the database of the point of sale system includes the particular native language desired for a translated receipt in the one or more native language descriptions of products associated with the product identifiers. If the test of step 310 determines that the database does not contain descriptions in the desired native language, the method advances to step 309 to print a standard receipt. If the test of step 310 determines that the database does contain descriptions in the desired native language, the method advances to step 311 to print a translated receipt using the native language descriptions of products associated with the product identifiers from the database of the point of sale system.

Such translated receipt printed at step 311 identifies purchases as line items and in the purchaser's native language. The translated receipt also includes the price paid for each line item, but the prices paid for each line item and total amount due might generally be in the currency where purchased. More advanced systems might do currency exchange at the point of sale machine, in which case the prices paid for each line item and total amount due might generally be in the native currency specified by the purchaser. In such case, the point of sale system might be coupled to financial services databases, such as maintained by Visa®, MasterCard®, and American Express®, in order to obtain the currency exchange rate imposed at the time of purchase. Native currency might also be included in, and read from, the “Discretionary Data” field of the magnetic strip in, for example, a credit card.

Some embodiments of the present invention might include a feature wherein the point of sale system automatically reads default language information from a user's mobile communication device. For such feature, a user might have a “user's default language” message periodically broadcast through a low-power radio, such as in near-field communication applications. In such case, the point of sale device might include a built-in wireless receiver (e.g., 802.11, 802.15, or the like) that automatically reads the default language from the “user's default language” message and then sets the parameters for printing receipts to include a translated receipt in accordance with the teachings herein.

While the described exemplary embodiment is with respect to a point of sale system acting as a cash register, the present invention is not so limited. Other embodiments might correspond to automatic teller machines (ATMs) or vending machines. In such other embodiments, as taught herein, the point of sale system again receives user input selecting a product or service, associates the product or service with a product identifier in a database that has a corresponding description field in a native description and one or more non-native descriptions, receives information as to which desired language(s) a receipt should be printed in, and then provides a receipt in the desired language(s).

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of receipt translation, the method comprising:
a) receiving one or more product identifiers;
b) associating, by a controller, each received product identifier with a corresponding entry in a database of product identification information, wherein i) each entry of the database corresponds to a product identifier, and ii) each entry comprises a description field having a standard language description and one or more native language descriptions;
c) receiving receipt language information; and
d) selecting, by the controller, the native language description for each received product identifier based on the received receipt language information.

2. The invention of claim 1, further comprising the step of:
providing a receipt for the one or more product identifiers based on the corresponding selected native language descriptions.

3. The invention of claim 1, wherein, for step a), the one or more product identifiers are received by either (i) the step of scanning the product identifier from a product or (ii) the step of manually inputting the product identifier.

4. The invention of claim 1 wherein, for step c), the receipt language information is received by either (i) the step of reading a default language from a payment device or (ii) the step of manually inputting the receipt language information.

5. The invention of claim 4, wherein, for the step of reading the default language from the payment device, the payment device is a credit card and the default language is read from at least one track of magnetic stripe of the credit card.

6. The invention of claim 4, wherein, for the step of reading the default language from the payment device, the payment device is a mobile communication device and the default language is a user's default language message read from a radio link with the mobile communication device.

7. The invention of claim 1, wherein step d) further comprises the steps of:
determining whether the receipt language information corresponds to one of either the standard language description or the one or more native language descriptions; and
setting, if the receipt language information does not correspond to one of either the standard language description or the one or more native language descriptions, the native language description for each received product identifier as the standard language description.

8. The invention of claim 1, further comprising the steps of:
converting a price for each received product identifier into a currency corresponding to the received receipt language information; and
providing a receipt for the one or more product identifiers in the currency corresponding to the received receipt language information.

9. The invention of claim 1, wherein the method is implemented by a processor of a point of sale device.

10. Apparatus for receipt translation, the apparatus comprising:
a first sensor configured to receive one or more product identifiers;
a database of product identification information, wherein i) each entry of the database corresponds to a product identifier, and ii) each entry comprises a description field having a standard language description and one or more native language descriptions;
a controller configured to associate each received product identifier with a corresponding entry in the database; and
a second sensor configured to receive receipt language information;
wherein the controller is further configured to select the native language description for each received product identifier based on the received receipt language information.

11. The invention of claim 10, further comprising:
a printer configured to provide a receipt for the one or more product identifiers based on the corresponding selected native language descriptions.

12. The invention of claim 10, wherein the first sensor is at least one of a scanner and a manual input device.

13. The invention of claim 10 wherein the second sensor receives the receipt language information by either (i) reading a default language from a payment device or (ii) manual input of the receipt language information.

14. The invention of claim 13, wherein the payment device is a credit card and the default language is read from at least one track of magnetic stripe of the credit card.

15. The invention of claim 13, wherein the payment device is a mobile communication device and the default language is a user's default language message read by the second sensor from a radio link with the mobile communication device.

16. The invention of claim 10, wherein the controller is further configured to i) determine whether the receipt language information corresponds to one of either the standard language description or the one or more native language descriptions; and ii) set, if the receipt language information does not correspond to one of either the standard language description or the one or more native language descriptions, the native language description for each received product identifier as the standard language description.

17. The invention of claim 10, further comprising:
a converter configured to convert a price for each received product identifier into a currency corresponding to the received receipt language information; and
a printer configured to provide a receipt for the one or more product identifiers in the currency corresponding to the received receipt language information.

18. The invention of claim 10, wherein the apparatus is embodied in a point of sale device.

19. A machine-readable storage medium, having encoded thereon program code, wherein, when the program code is executed by a machine, the machine implements a method for receipt translation, comprising the steps of:
a) receiving one or more product identifiers;
b) associating each received product identifier with a corresponding entry in a database of product identification information, wherein i) each entry of the database corresponds to a product identifier, and ii) each entry comprises a description field having a standard language description and one or more native language descriptions;
c) receiving receipt language information;
d) selecting the native language description for each received product identifier based on the received receipt language information; and
e) providing a receipt for the one or more product identifiers based on the corresponding selected native language descriptions.

20. The invention of claim 19, further comprising:
converting a price for each received product identifier into a currency corresponding to the received receipt language information; and
providing the receipt for the one or more product identifiers in the currency corresponding to the received receipt language information.
